(19) United States
(12) Patent Application Publication
(10) Pub. No.: US 2012/0299844 A1
(43) Pub. Date: Nov. 29, 2012

(54) DISPLAY DEVICE

(75) Inventor: Chien-Hsiang Huang, Tainan City (TW)

(73) Assignee: HANNSTAR DISPLAY CORP., New Taipei City (TW)

(21) Appl. No.: 13/275,062

(22) Filed: Oct. 17, 2011

(30) Foreign Application Priority Data
May 25, 2011 (TW) 100118386

(51) Int. Cl. G06F 3/041

(52) U.S. Cl. 345/173

(57) ABSTRACT

The display device includes a touch plate, a sensing plate, a first distance and a second distance. The touch plate includes a first area having a first thickness and a second area having a second thickness. The first thickness is larger than the second thickness. The sensing plate is disposed below the touch plate. The first distance is a shortest distance between the sensing plate and the touch plate on the first area. The second distance is a shortest distance between the sensing plate and the touch plate on the second area. The first distance is shorter than the second distance.

### CROSS REFERENCE TO RELATED APPLICATIONS

The application claims the benefit of Taiwan Patent Application No. 100118386, filed on May 25, 2011, at the Taiwan Intellectual Property Office, the disclosures of which are incorporated herein in their entirety by reference.

### FIELD OF THE INVENTION

The present invention relates to a display device, especially to a liquid-crystal touch-panel display device.

### BACKGROUND OF THE INVENTION

In the past, since the sensitivity of the touch control for touch panels is not high enough, the touch-panel screens only appear as the display devices with larger areas for the touch-control commands on the screen, e.g. ticket issuing machines, vending machines, tour information machines, etc. Most display devices, e.g. computer monitors, notebook computers, etc., still adopt the mice with much higher sensitivity. As the technologies of the touch panels are continuously advancing, the sensitivity of the touch control has been raised, and the technologies of dual-point touch controls appear and bring great convenience for users. Thus, the touch panels are gradually and widely applied to the portable display devices, e.g. tablet computers, smart mobile phones, etc., and become widely popular to most users.

However, most of the users, who have used the touch panels, can recognize that the sensitivity of the touch control for the touch panels is still lower than that of the control for the mice. Therefore, there still exist plenty of rooms for the researcher to develop and raise the sensitivity of the touch control for the touch panels.

Please refer to FIG. 1, which is the schematic diagram showing a cross-sectional view in the thickness direction for the conventional touch panel of the prior art. In FIG. 1, the cover lens 11 is located right above the indium-tin-oxide (ITO) sensing plate 13. Both the cover lens 11 and ITO sensing plate 13 have exactly or proximately the same size. The ITO sensing plate 13 has the thickness d₀. The surrounding edges of the cover lens 11 and the ITO sensing plate 13 are applied with the adhesive 15 so as to adhere the cover lens 11 to the ITO sensing plate 13. When the finger 10 (or touch pen) touches the cover lens 11, the ITO sensing plate 13 can sense the touched position on the cover lens 11 by the finger 10 so as to undergo the control similar to the mouse. Generally speaking, the intensity of the sensed touch-control signal by the ITO sensing plate 13 is related to the distance D₁ between the touched position on the cover lens 11 by the finger 10 and the position right below the touched position, on the ITO sensing plate 13. Usually, the shorter the distance D₁, the stronger the touch-control signal.

Since the sensitivity of the touch control for the touch panels still needs to be improved, in order to solve this issue, the inventor had done a lot of experiments, and finally developed a novel touch panel able to provide the higher sensitivity of the touch control for the touch panels.

### SUMMARY OF THE INVENTION

In accordance with one aspect of the present invention, a display device is provided. The display device includes a touch plate, a sensing plate, a first distance and a second distance. The touch plate includes a first area having a first thickness and a second area having a second thickness, wherein the first thickness is larger than the second thickness. The sensing plate is disposed below the touch plate. The first distance is a shortest distance between the sensing plate and the touch plate on the first area. The second distance is a shortest distance between the sensing plate and the touch plate on the second area, wherein the first distance is shorter than the second distance.

In accordance with another aspect of the present invention, a display device is provided. The display device includes a touch plate, which includes a protruding structure protruding downwards, and a sensing plate disposed below the touch plate and directly contacted with the protruding structure.

In accordance with a further aspect of the present invention, a display device is provided. The display device includes a touch plate receiving a touch-control command from a user. The touch plate includes a first part having a surface and a first thickness and a second part extended from the surface and having a second thickness, wherein the first thickness and the second thickness have a sum being a usually-used thickness of the touch plate.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is the schematic diagram showing a cross-sectional view in the thickness direction for the conventional touch panel of the prior art;

FIG. 2 is the schematic diagram showing a cross-sectional view in the thickness direction for the display device in one embodiment of the present invention;

FIG. 3 is the schematic diagram showing a cross-sectional view in the thickness direction for the display device in another embodiment of the present invention;

FIG. 4 is the schematic diagram showing a cross-sectional view in the thickness direction for the display device in another embodiment of the present invention;

FIG. 5 is the schematic diagram showing a cross-sectional view in the thickness direction for the display device in another embodiment of the present invention;

FIG. 6A is the schematic diagram showing a top view for the display device in another embodiment of the present invention;

FIG. 6B is the schematic diagram showing a cross-sectional view for the display device in FIG. 6A of the present invention by cutting along the C-C dash line in the thickness direction;

FIG. 7A is the schematic diagram showing a top view for the display device in another embodiment of the present invention;

FIG. 7B is the schematic diagram showing a top view for the display device in another embodiment of the present invention;

FIG. 8A is the schematic diagram showing a top view for the display device in another embodiment of the present invention; and

FIG. 8B is the schematic diagram showing a top view for the display device in the other embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

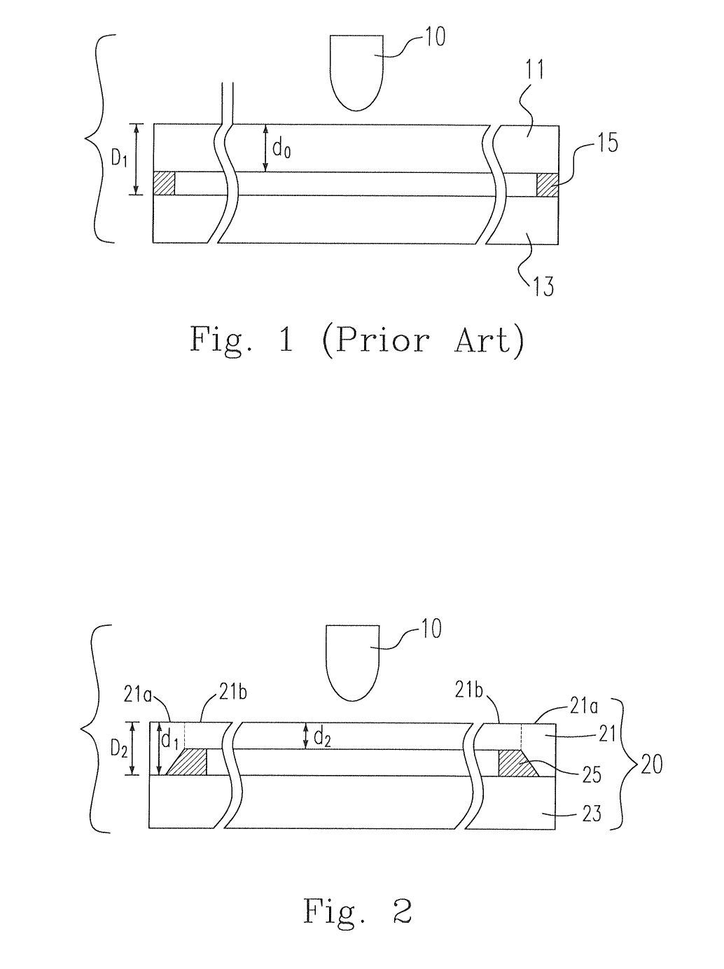

Please refer to FIG. 2, which is the schematic diagram showing a cross-sectional view in a thickness direction for a display device 20 in one embodiment of the present invention. As shown in FIG. 2, a touch plate 21, e.g. a cover lens, etc., includes a first area 21a and a second area 21b, where the first area 21a has a first thickness d₁, the second area 21b has a second thickness d₂, and the first thickness d₁ is thicker than the second thickness d₂. A sensing plate 23, e.g. a transparent ITO sensing plate, is disposed right below the touch plate 21. The distance between the touched position by a finger 10 and the sensing plate 23 is denoted as D₂. In this embodiment, the thickness d₁ of the touch plate 21 in the first area 21a is equal to the thickness d₀ of the conventional cover lens 11 in FIG. 1. Since the first area 21a of the touch plate 21 is contacted with the sensing plate 23, the distance D₂ between the touched position by the finger 10 on the touch plate 21 and the position right below the touched position and on the sensing plate 23 is shorter than the distance D₁ between the touched position by the finger 10 on the cover lens 11 and the position right below the touched position and on the ITO sensing plate 13. That is to say, the touched position by the finger 10 in this embodiment is closer to the sensing plate than that in the conventional technology, and accordingly the sensing plate 23 can receive stronger sensing signal. In this embodiment, the sensing plate 23 can be the sensing plate of the capacitance type, can receive lager capacitance value, and can effectively raise the touch-control sensitivity.

The theory of the touch-control sensing is described as follows. When the finger(s) touches a touched position on the touch plate, the variation (usually become larger) of the capacitance on the sensing position, corresponding to the touched position, on the sensing plate can be sensed, where the touch position is located right above the sensing position, and accordingly the signal containing the information regarding the sensing position can be output.

In this embodiment, the dimensions of the touch plate 21 can be equivalent to or close to those of the sensing plate 23. The first area 21a can be selectively disposed on surrounding edge area of the touch plate 21 to form the frame structure. The space between the touch plate 21 and the sensing plate 23 can be selectively applied or filled with an adhesive 25 to fix the touch plate 21 onto the sensing plate 23. Other fixing methods can be adopted instead. The space of applying the adhesive 25 can be located on the second area 21b, which is located around a connection area between the first area 21a and the second area 21b, and in the space between the touch plate 21 and the sensing plate 23, as shown in FIG. 2. A thermosetting heat curing adhesive, an ultra-violet-ray curing adhesive, dual-part curing adhesive, or other transparent adhesives can be appropriately selected as the adhesive 25. The rest space between the second area 21b and the sensing plate 23 can be optionally filled with at least one transparent adhesive, e.g. hydrogel, water-soluble adhesive, the same adhesive as the adhesive 25, or other adhesives.

The display device in this embodiment can be a liquid crystal touch panel display device. There are plural liquid crystal pixel structures below the sensing plate 23. The material of the touch plate 21 can be selected from a group consisting of glass, quartz, poly(methyl methacrylate) (i.e. PMMA), polycarbonate, poly(ethylene terephthalate) (i.e. PET), etc. The sensing plate 23 can be a transparent indium tin oxide (ITO) sensing plate, and can contain matrix type circuits made by the transparent ITO material, so the sensing plate 23 is able to sense the position, corresponding to a Cartesian coordinate, touched by the user's finger.

In this embodiment, the maximum thickness of the touch plate 21 in the first area 21a is d₁. For the convenience of the manufacturing, the thickness of the touch plate 21 in a part of the first area 21a is gradually reduced from the maximum first thickness d₁ down to the second thickness d₂ of the touch plate 21 in the second area 21b to form a slope as shown in FIG. 2. Thus, the touch plate 21 in the first area 21a in this embodiment can have different thicknesses. Of course, the touch plate 21 in the first area 21a can also be designed to have the same first thickness all over the first area 21a based on the concept of the present invention to reach the efficacies of increasing the sensed capacitance and enhancing the sensitivity of the touch control.

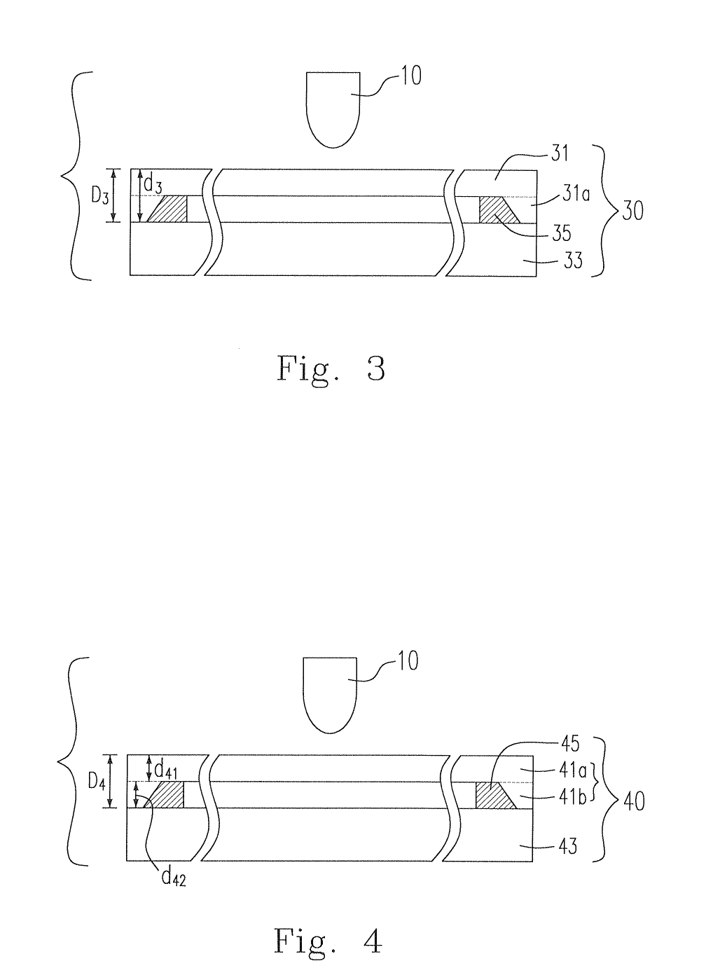

Please refer to FIG. 3, which is the schematic diagram showing a cross-sectional view in the thickness direction for the display device 30 in another embodiment of the present invention. As shown in FIG. 3, the display device in this embodiment includes a touch plate 31 and sensing plate 33. The touch plate 31 has a protruding structure 31a, and the sensing plate 33 is configured below the touch plate 31 and contacted with the protruding structure 31a. In this embodiment, the maximum thickness d₃ of the touch plate 31 is equal to the thickness d₀ of the conventional cover lens 11 in FIG. 1. Since the protruding structure 31a of the touch plate 31 is contacted with the sensing plate 33, the distance D₃ between the touched position by the finger 10 on the touch plate 31 and the position right below the touched position and on the sensing plate 33 is shorter than the distance D₁ between the touched position by the finger 10 on the cover lens 11 and the position right below the touched position and on the ITO sensing plate 13. That is to say, the touched position by the finger 10 in this embodiment is closer to the sensing plate than that in the conventional technology, and accordingly the sensing plate 33 can receive stronger sensing signal. In this embodiment, the sensing plate 33 can be the sensing plate of the capacitance type, can receive lager capacitance value, and can effectively raise the touch-control sensitivity.

Similarly, in this embodiment, the dimensions of the touch plate 31 can be equivalent to or close to those of the sensing plate 33. The protruding structure 31a can be optionally disposed on surrounding edge area of the touch plate 31 to form a frame structure. The space between the touch plate 31 and the sensing plate 33 can be selectively applied or filled with an adhesive 35 to fix the touch plate 31 onto the sensing plate 33. Other fixing methods can be adopted instead. The space of applying the adhesive 35 can be located next to the protruding structure 31a and in the space between the touch plate 31 and the sensing plate 33, as shown in FIG. 3. A thermosetting heat curing adhesive, an ultra-violet-ray curing adhesive, dual-part curing adhesive, or other transparent adhesives can be appropriately selected as the adhesive 35. The rest space between the touch plate 31 and the sensing plate 33 can be optionally filled with at least one transparent adhesive, e.g. hydrogel, water-soluble adhesive, the same adhesive as the adhesive 35, or other adhesives.

Similarly, the display device in this embodiment can be a liquid crystal touch panel display device. There are plural liquid crystal pixel structures below the sensing plate 33. The material of the touch plate 31 can be selected from a group consisting of glass, quartz, poly(methyl methacrylate) (i.e. PMMA), polycarbonate, poly(ethylene terephthalate) (i.e. PET), etc. The sensing plate 33 can be a transparent indium tin oxide (ITO) sensing plate, and can contain matrix type circuits made by the transparent ITO material, so the sensing plate 33 is able to sense the position, corresponding to a Cartesian coordinate, touched by the user's finger.

Please refer to FIG. 4, which is the schematic diagram showing a cross-sectional view in the thickness direction for the display device 40 in another embodiment of the present invention. As shown in FIG. 4, the display device 40 in this embodiment includes a touch plate 41, which contains a first part 41a and a second part 41b. The first part 41a has a surface and a first thickness d₄₁, and the second part 41b is extended from the surface of the first part 41a and has a second thickness d₄₂. The sum of the first thickness d₄₁ and the second thickness d₄₂ is equal to a usually-used thickness d₀ shown in FIG. 1.

Since the second part 41b of the touch plate 41 is contacted with the sensing plate 43, the distance D₄ between the touched position by the finger 10 on the touch plate 41 and the position right below the touched position and on the sensing plate 43 is shorter than the distance D₁ between the touched position by the finger 10 on the cover lens 11 and the position right below the touched position and on the ITO sensing plate 13. That is to say, the touched position by the finger 10 in this embodiment is closer to the sensing plate than that in the conventional technology, and accordingly the sensing plate 43 can receive stronger sensing signal. In this embodiment, the sensing plate 43 can be the sensing plate of the capacitance type, can receive lager capacitance value, and can effectively raise the touch-control sensitivity.

Similarly, in this embodiment, the dimensions of the touch plate 41 can be equivalent to or close to those of the sensing plate 43. The second part 41b can be selectively disposed on surrounding edge area of the touch plate 41 to form the frame structure. The space between the touch plate 41 and the sensing plate 43 can be selectively applied or filled with an adhesive 45 to fix the touch plate 41 onto the sensing plate 43. Other fixing methods can be adopted instead. The space of applying the adhesive 45 can be located next to the second part 41b and in the space between the touch plate 41 and the sensing plate 43, as shown in FIG. 4. A thermosetting heat curing adhesive, an ultra-violet-ray curing adhesive, dual-part curing adhesive, or other transparent adhesives can be appropriately selected as the adhesive 45. The rest space between the touch plate 41 and the sensing plate 43 can be optionally filled with at least one transparent adhesive, e.g. hydrogel, water-soluble adhesive, the same adhesive as the adhesive 45, or other adhesives.

Similarly, the display device in this embodiment can be a liquid crystal touch panel display device. There are plural liquid crystal pixel structures below the sensing plate 43. The material of the touch plate 41 can be selected from a group consisting of glass, quartz, poly(methyl methacrylate) (i.e. PMMA), polycarbonate, poly(ethylene terephthalate) (i.e. PET), etc. The sensing plate 43 can be a transparent indium tin oxide (ITO) sensing plate, and can contain matrix type circuits made by the transparent ITO material, so the sensing plate 43 is able to sense the position, corresponding to a Cartesian coordinate, touched by the user's finger.

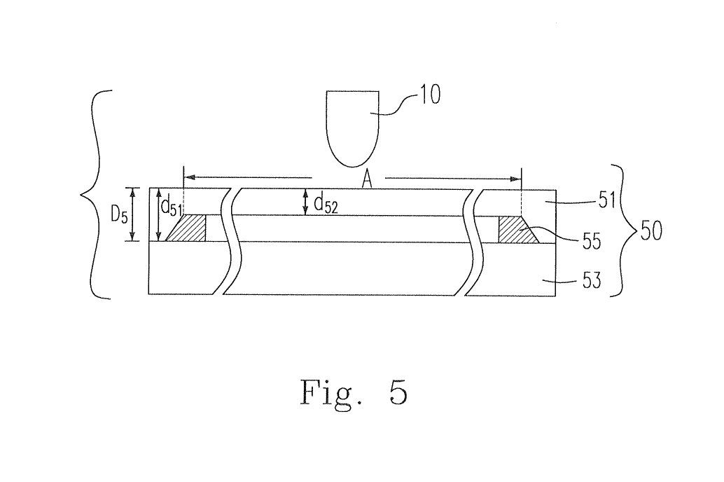

Please refer to FIG. 5, which is the schematic diagram showing a cross-sectional view in the thickness direction for the display device 50 in another embodiment of the present invention. As shown in FIG. 5, the display device 50 of the present embodiment includes a touch plate 51, which has a usually-used thickness d₅₁ and a working area A. The thickness of the touch plate 51 in the working area is the working thickness d₅₂, and the working thickness d₅₂ is smaller than or equal to 90% of the usually-used thickness d₅₁. For example, when the usually-used thickness d₅₁ is 0.7 mm, the working thickness d₅₂ can be 0.63 mm (i.e. 90% of the usually-used thickness d₅₁), 0.595 mm (i.e. 85% of the usually-used thickness d₅₁), 0.56 mm (i.e. 80% of the usually-used thickness d₅₁), 0.5 mm (i.e. 71% of the usually-used thickness d₅₁), 0.4 mm (i.e. 57% of the usually-used thickness d₅₁), or thinner thickness.

Since the part of the touch plate 51, with the usually-used thickness, is contacted with the sensing plate 53, the distance D₅ between the touched position by the finger 10 on the touch plate 51 and the position right below the touched position and on the sensing plate 53 is shorter than the distance D₁ between the touched position by the finger 10 on the cover lens 11 and the position right below the touched position and on the ITO sensing plate 13. That is to say, the touched position by the finger 10 in this embodiment is closer to the sensing plate than that in the conventional technology, and accordingly the sensing plate 53 can receive stronger sensing signal. In this embodiment, the sensing plate 53 can be the sensing plate of the capacitance type, can receive lager capacitance value, and can effectively raise the touch-control sensitivity.

Similarly, in this embodiment, the dimensions of the touch plate 51 can be equivalent to or close to those of the sensing plate 53. The working area A can be selectively disposed on the central area of the touch plate 51, and the part of the touch plate 51, with the usually-used thickness, can be disposed on the surrounding edge area of the touch plate 51 to form the frame structure. The space between the touch plate 51 and the sensing plate 53 can be selectively applied or filled with an adhesive 55 to fix the touch plate 51 onto the sensing plate 53. Other fixing methods can be adopted instead. The space of applying the adhesive 55 can be located within the frame structure and in the space between the touch plate 51 and the sensing plate 53, as shown in FIG. 5. A thermosetting heat curing adhesive, an ultra-violet-ray curing adhesive, dual-part curing adhesive, or other transparent adhesives can be appropriately selected as the adhesive 55. The rest space between the touch plate 51 and the sensing plate 53 can be optionally filled with at least one transparent adhesive, e.g. hydrogel, water-soluble adhesive, the same adhesive as the adhesive 55, or other adhesives.

Similarly, the display device 50 in this embodiment can be a liquid crystal touch panel display device. There are plural liquid crystal pixel structures below the sensing plate 53. The material of the touch plate 51 can be selected from a group consisting of glass, quartz, poly(methyl methacrylate) (i.e. PMMA), polycarbonate, poly(ethylene terephthalate) (i.e. PET), etc. The sensing plate 53 can be a transparent indium tin oxide (ITO) sensing plate, and can contain matrix type circuits made by the transparent ITO material, so is able to sense the position, corresponding to a Cartesian coordinate, touched by the user's finger.

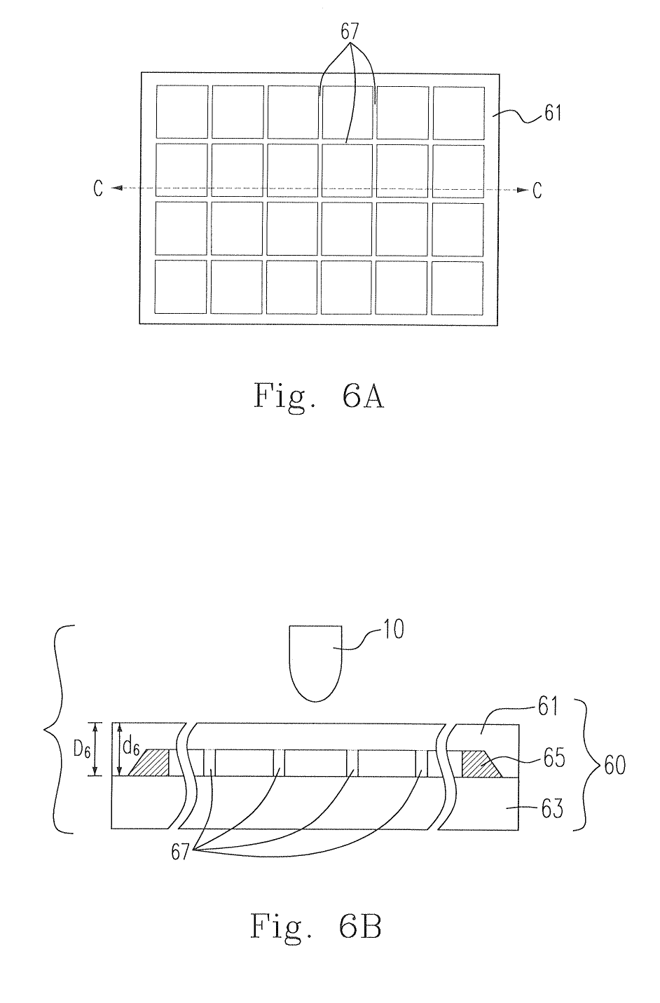

Please refer to FIG. 6A, which is the schematic diagram showing a top view for the display device 60 in another embodiment of the present invention. Please also refer to FIG. 6B, which is the schematic diagram showing a cross-sectional view for the display device 60 in FIG. 6A of the present invention by cutting along the C-C dash line in the thickness direction. As shown in FIG. 6B, the display device 60 in this embodiment includes a touch plate 61 and a sensing plate 63, where the touch plate 61 includes an additional bolstering structure and the other structures can be the same as the touch plates 21, 31, 41 or 51 described in the above embodiments. In this embodiment, the part of the touch plate 61 with the maximum thickness d₆ can be located in the surrounding edge area of the touch plate 61, and the maximum thickness d₆ is equal to the thickness d₁ of the cover lens in the conventional technique. Since the part of the touch plate 41 with the maximum thickness d₆ is directly contacted with the sensing plate 63, the distance D₆ between the touched position by the finger 10 on the touch plate 61 and the position right below the touched position and on the sensing plate 63 is shorter than the distance D₁ between the touched position by the finger 10 on the cover lens 11 and the position right below the touched position and on the ITO sensing plate 13. That is to say, the touched position by the finger 10 in this embodiment is closer to the sensing plate than that in the conventional technology, and accordingly the sensing plate 63 can receive stronger sensing signal. In this embodiment, the sensing plate 63 can be the sensing plate of the capacitance type, can receive lager capacitance value, and can effectively raise the touch-control sensitivity.

Similarly, the space between the touch plate 61 and the sensing plate 63 can be selectively applied or filled with an adhesive 65 to fix the touch plate 61 onto the sensing plate 63. Other fixing methods can be adopted instead. The space of applying the adhesive 65 can be located within the structure with the maximum thickness d₆ and in the space between the touch plate 61 and the sensing plate 63, as shown in FIG. 6. A thermosetting heat curing adhesive, an ultra-violet-ray curing adhesive, dual-part curing adhesive, or other transparent adhesives can be appropriately selected as the adhesive 65. The rest space between the touch plate 61 and the sensing plate 63 can be optionally filled with at least one transparent adhesive, e.g. hydrogel, water-soluble adhesive, the same adhesive as the adhesive 65, or other adhesives.

Similarly, the display device 60 in this embodiment can be a liquid crystal touch panel display device. There are plural liquid crystal pixel structures below the sensing plate 63. The material of the touch plate 61 can be selected from a group consisting of glass, quartz, poly(methyl methacrylate) (i.e. PMMA), polycarbonate, poly(ethylene terephthalate) (i.e. PET), etc. The sensing plate 63 can be a transparent indium tin oxide (ITO) sensing plate, and can contain matrix type circuits made by the transparent ITO material, so the sensing plate 63 is able to sense the position, corresponding to a Cartesian coordinate, touched by the user's finger.

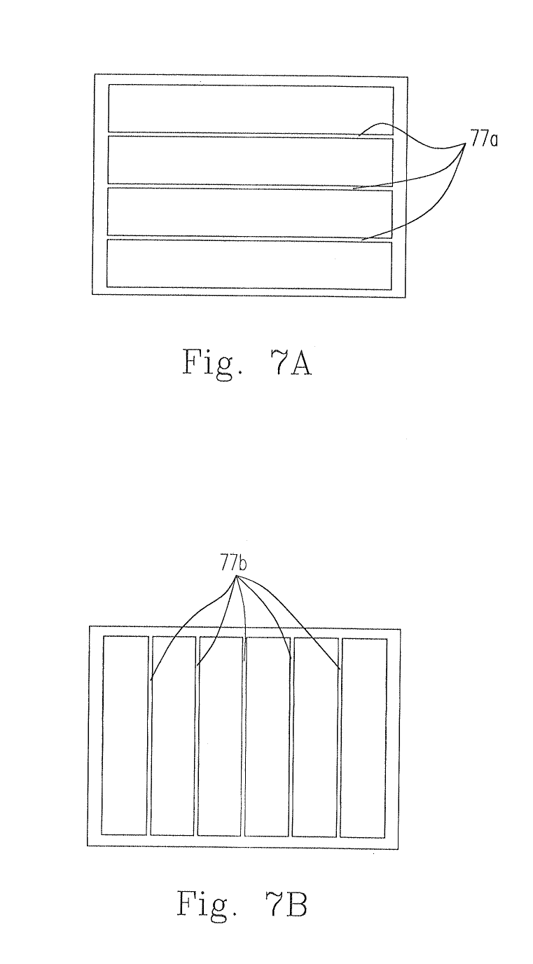

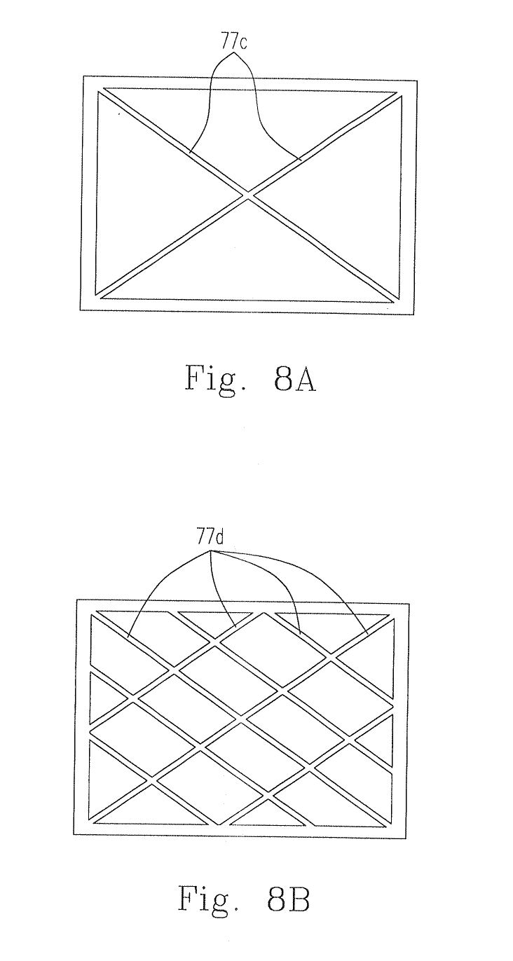

It can be seen from the top view diagram in FIG. 6A that the bolstering structure 67 is formed by several wall structures parallel to or perpendicular to one another, so as to reinforce the mechanical strength in the central display area with the thinner thickness than that in the surrounding edge area. In this embodiment, it can be seen from the top view diagram in FIG. 6A that the bolstering structure 67 shows a grid structure. Certainly, based on the concepts of the present invention, the bolstering structure 67 can be designed to be the bolstering structures 77a, 77b, 77c or 77d as shown in FIGS. 7A, 7B, 8A and 8B or other bolstering structures without the limitation in the shape as long as the bolstering structure is located on the touch plate to reinforce the mechanical strength thereof. Basically, the grid and/or strip structures can be preferably selected as the bolstering structures.

The examples of the present invention are described in the followings.

1. A display device includes a touch plate, a sensing plate and a first distance and a second distance. The touch plate includes a first area having a first thickness and a second area having a second thickness, wherein the first thickness is larger than the second thickness. The sensing plate is disposed below the touch plate. The first distance is a shortest distance between the sensing plate and the touch plate on the first area. The second distance is a shortest distance between the sensing plate and the touch plate on the second area, wherein the first distance is shorter than the second distance.

2. A display device of Example 1 is one of a liquid-crystal touch-panel display device and an organic-light-emitting-diode touch-panel display device, wherein the touch plate includes a cover lens; and the touch plate includes a material being one selected from a group consisting of a glass, a quartz, a poly(methyl methacrylate), a polycarbonate, and a poly(ethylene terephthalate).

3. A display device of any of the preceding examples further includes plural liquid-crystal pixel structures below the sensing plate, wherein the sensing plate includes a transparent indium-tin-oxide sensing plate, and the display device has a space between the touch plate and the sensing plate, wherein the space is filled with an adhesive in a way being one of a full fill and a partial fill, so as to adhere the touch plate to the sensing plate, wherein the adhesive includes a transparent adhesive.

4. A display device of any of the preceding examples, wherein the sensing plate sends out a signal including an information of a sensed position on the sensing plate, when sensing a capacitance variation on the sensed position as an object touches a touched position, corresponding to the sensed position, on the touch plate, wherein the touched position is located right above the sensed position.

5. A display device of any of the preceding examples, wherein the first thickness is one of a fixed thickness and a variable thickness, over the first area, the second thickness remains unchanged all over the second area; the touch plate has a surrounding edge area, and the first area includes an edge area disposed on the surrounding edge area to form a frame structure.

6. A display device of any of the preceding examples, wherein the first area further includes a central area being one of a strip area and a grid area, each of which is disposed within the surrounding edge area to form a bolstering structure.

7. A display device includes a touch plate including a protruding structure protruding downwards, and a sensing plate disposed below the touch plate and directly contacted with the protruding structure.

8. A display device of any of the preceding examples is one of a liquid-crystal touch-panel display device and an organic-light-emitting-diode touch-panel display device, wherein the touch plate includes a cover lens, and the touch plate includes a material being one selected from a group consisting of a glass, a quartz, a poly(methyl methacrylate), a polycarbonate, and a poly(ethylene terephthalate).

9. A display device of any of the preceding examples further includes plural liquid-crystal pixel structures below the sensing plate, wherein the sensing plate includes a transparent indium-tin-oxide sensing plate, and the display device has a space between the touch plate and the sensing plate, wherein the space is filled with an adhesive in a way being one of a full fill and a partial fill, so as to adhere the touch plate to the sensing plate, wherein the adhesive includes a transparent adhesive.

10. A display device of any of the preceding examples, wherein the sensing plate sends out a signal including an information of a sensed position on the sensing plate, when sensing a capacitance variation on the sensed position as an object touches a touched position, corresponding to the sensed position, on the touch plate, wherein the touched position is located right above the sensed position.

11. A display device of any of the preceding examples, wherein the touch plate has a surrounding edge area, and the protruding structure is disposed on the surrounding edge area to form a frame structure.

12. A display device of any of the preceding examples, wherein the protruding structure includes one of a strip structure and a grid structure, each of which is disposed within the surrounding edge area to form a bolstering structure.

13. A display device includes a touch plate receiving a touch-control command from a user. The touch plate includes a first part having a surface and a first thickness, and a second part extended from the surface and having a second thickness, wherein the first thickness and the second thickness have a sum being a usually-used thickness of the touch plate.

14. A display device of any of the preceding examples is one of a liquid-crystal touch-panel display device and an organic-light-emitting-diode touch-panel display device, wherein the touch plate includes a cover lens, and the touch plate includes a material being one selected from a group consisting of a glass, a quartz, a poly(methyl methacrylate), a polycarbonate, and a poly(ethylene terephthalate).

15. A display device of any of the preceding examples further includes a sensing plate disposed below the touch plate, and plural liquid-crystal pixel structures disposed below the sensing plate.

16. A display device of any of the preceding examples, wherein the sensing plate includes a transparent indium-tin-oxide sensing plate, and the display device has a space between the touch plate and the sensing plate, wherein the space is filled with an adhesive in a way being one of a full fill and a partial fill, so as to adhere the touch plate to the sensing plate, wherein the adhesive includes a transparent adhesive.

17. A display device of any of the preceding examples, wherein the sensing plate sends out a signal including an information of a sensed position on the sensing plate, when sensing a capacitance variation on the sensed position as an object touches a touched position, corresponding to the sensed position, on the touch plate, wherein the touched position is located right above the sensed position

18. A display device of any of the preceding examples, wherein the touch plate has a surrounding edge area, and the second part includes an edge part disposed on the surrounding edge area to form a frame structure.

19. A display device of any of the preceding examples, wherein the second part further includes a central part being one of a strip part and a grid part, each of which is disposed within the surrounding edge area to form a bolstering structure.

20. A display device of any of the preceding examples, wherein the first thickness is one of two states being thinner than and equal to 90% of the usually-used thickness of the touch plate.

As described above, the present invention provide the display devices able to enhance the touch sensing signal of the touch panel and effectively raise the touch control sensitivity so that the touch panel display devices can be more conveniently and easily manipulated and the great benefits can be brought to the users.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a touch plate including:
a first area having a first thickness; and
a second area having a second thickness, wherein the first thickness is larger than the second thickness;
a sensing plate disposed below the touch plate;
a first distance being a shortest distance between the sensing plate and the touch plate on the first area; and
a second distance being a shortest distance between the sensing plate and the touch plate on the second area, wherein the first distance is shorter than the second distance.

2. A display device of claim 1, being one of a liquid-crystal touch-panel display device and an organic-light-emitting-diode touch-panel display device, wherein:
the touch plate includes a cover lens; and
the touch plate includes a material being one selected from a group consisting of a glass, a quartz, a poly(methyl methacrylate), a polycarbonate, and a poly(ethylene terephthalate).

3. A display device of claim 1, further comprising plural liquid-crystal pixel structures below the sensing plate, wherein:
the sensing plate includes a transparent indium-tin-oxide sensing plate; and
the display device has a space between the touch plate and the sensing plate, wherein the space is filled with an adhesive in a way being one of a full fill and a partial fill, so as to adhere the touch plate to the sensing plate, wherein the adhesive includes a transparent adhesive.

4. A display device of claim 1, wherein the sensing plate sends out a signal including an information of a sensed position on the sensing plate, when sensing a capacitance variation on the sensed position as an object touches a touched position, corresponding to the sensed position, on the touch plate, wherein the touched position is located right above the sensed position.

5. A display device of claim 1, wherein:
the first thickness is one of a fixed thickness and a variable thickness, over the first area;
the second thickness remains unchanged all over the second area;
the touch plate has a surrounding edge area; and
the first area includes an edge area disposed on the surrounding edge area to form a frame structure.

6. A display device of claim 5, wherein the first area further includes a central area being one of a strip area and a grid area, each of which is disposed within the surrounding edge area to form a bolstering structure.

7. A display device, comprising:
a touch plate including a protruding structure protruding downwards; and
a sensing plate disposed below the touch plate, and directly contacted with the protruding structure.

8. A display device of claim 7, being one of a liquid-crystal touch-panel display device and an organic-light-emitting-diode touch-panel display device, wherein:
the touch plate includes a cover lens; and
the touch plate includes a material being one selected from a group consisting of a glass, a quartz, a poly(methyl methacrylate), a polycarbonate, and a poly(ethylene terephthalate).

9. A display device of claim 7, further comprising plural liquid-crystal pixel structures below the sensing plate, wherein:
the sensing plate includes a transparent indium-tin-oxide sensing plate; and
the display device has a space between the touch plate and the sensing plate, wherein the space is filled with an adhesive in a way being one of a full fill and a partial fill, so as to adhere the touch plate to the sensing plate, wherein the adhesive includes a transparent adhesive.

10. A display device of claim 7, wherein the sensing plate sends out a signal including an information of a sensed position on the sensing plate, when sensing a capacitance variation on the sensed position as an object touches a touched position, corresponding to the sensed position, on the touch plate, wherein the touched position is located right above the sensed position.

11. A display device of claim 7, wherein the touch plate has a surrounding edge area, and the protruding structure is disposed on the surrounding edge area to form a frame structure.

12. A display device of claim 11, wherein the protruding structure includes one of a strip structure and a grid structure, each of which is disposed within the surrounding edge area to form a bolstering structure.

13. A display device, comprising:
a touch plate receiving a touch-control command from a user, including:
a first part having a surface and a first thickness; and
a second part extended from the surface, and having a second thickness, wherein the first thickness and the second thickness have a sum being a usually-used thickness of the touch plate.

14. A display device of claim 13, being one of a liquid-crystal touch-panel display device and an organic-light-emitting-diode touch-panel display device, wherein:
the touch plate includes a cover lens; and
the touch plate includes a material being one selected from a group consisting of a glass, a quartz, a poly(methyl methacrylate), a polycarbonate, and a poly(ethylene terephthalate).

15. A display device of claim 13, further comprising:
a sensing plate disposed below the touch plate; and
plural liquid-crystal pixel structures disposed below the sensing plate.

16. A display device of claim 15, wherein:
the sensing plate includes a transparent indium-tin-oxide sensing plate; and
the display device has a space between the touch plate and the sensing plate, wherein the space is filled with an adhesive in a way being one of a full fill and a partial fill, so as to adhere the touch plate to the sensing plate, wherein the adhesive includes a transparent adhesive.

17. A display device of claim 15, wherein the sensing plate sends out a signal including an information of a sensed position on the sensing plate, when sensing a capacitance variation on the sensed position as an object touches a touched position, corresponding to the sensed position, on the touch plate, wherein the touched position is located right above the sensed position.

18. A display device of claim 13, wherein the touch plate has a surrounding edge area, and the second part includes an edge part disposed on the surrounding edge area to form a frame structure.

19. A display device of claim 18, wherein the second part further includes a central part being one of a strip part and a grid part, each of which is disposed within the surrounding edge area to form a bolstering structure.

20. A display device of claim 13, wherein the first thickness is one of two states being thinner than and equal to 90% of the usually-used thickness of the touch plate.
